(19) United States
(12) Patent Application Publication
(10) Pub. No.: US 2012/0020599 A1
(43) Pub. Date: Jan. 26, 2012

(54) BUSHING OF BEARING AND TOOTHED LOOP FOR VARIABLE SPEED BICYCLE

(76) Inventor: Ting Yu Lo, Taichung City (TW)

(21) Appl. No.: 12/840,313

(22) Filed: Jul. 21, 2010

(51) Int. Cl. F16C 17/00

(52) U.S. Cl. 384/275

(57) ABSTRACT

A bushing of a bearing and a toothed loop for a variable speed bicycle comprises at least one dove-tail recess and dove-tail retaining projection fixed on two sides of a metal piece respectively; the toothed loop including a small-diameter hole disposed on a central portion thereof, the small-diameter hole including a large-diameter groove mounted on an upper side of the toothed loop, the large-diameter annular groove including plural teeth formed therearound; wherein the dove-tail recess includes two first titled surfaces arranged on two sides thereof individually, the dove-tail retaining projection includes two second titled surfaces arranged on two sides thereof individually, the metal piece is twisted to form a hollow cylinder so that the dove-tail recess and the dove-tail projection are connected together, and then they are engages with each other by using the first and second titled surfaces; the toothed loop is rejection molded from non-metal composite material.

### BACKGROUND OF THE INVENTION

1. Field of the Invention

The present invention relates to a bushing of a bearing and a toothed loop for a variable speed bicycle that can enhance production quantity, lower defect rate and production cost, prevent from rust, and obtain environmental friendly purpose.

2. Description of the Prior Art

As illustrated in FIGS. 1 and 2, a conventional bushing A of a bearing B of a variable speed bicycle is used to limit ball bearings C, C′, and the bushing A is made of metal material, twisted, and then welded together along a welding dotted line D. Thereafter, the bushing is ground, polished, and cut.

However, such a conventional bushing still has the following disadvantages:

1. The bushing is welded, therefore a crack happens easily.

2. After the bushing is welded, the bushing is ground, polished, and cut to increase production cost, lower quantity, and consume production material.

With reference to FIG. 3, a conventional toothed loop E includes a through hole E1, and the through hole E1 includes an annular groove E2 formed on an upper side thereof, and the annular groove E2 includes a number of teeth disposed around an inner rim thereof, and a circular projection E3 extending around an outer rim thereof. However, the toothed loop is made of metal material to increase production cost.

In addition, due to the toothed loop is made of metal material, a precise manufacturing standard is required, casing a high defect rate, a rust, an metal pollution, and decreasing production quantity,

As shown in FIG. 4, another conventional toothed loop includes a flat surface disposed on an upper side thereof, and the flat surface includes a raised tab F1 attached around an outer periphery thereof The toothed loop is made of non-metal composite material, and the raised tab F1 is thick to reinforce strength. Nevertheless, such a conventional toothed loop can not be adapted for variable speed bicycle.

The present invention has arisen to mitigate and/or obviate the afore-described disadvantages.

### SUMMARY OF THE INVENTION

The primary object of the present invention is to provide a bushing of a bearing and a toothed loop for a variable speed bicycle that can enhance production quantity and lower defect rate and production cost.

Another object of the present invention is to provide a bushing of a bearing and a toothed loop for a variable speed bicycle that can prevent from rust and obtain environmental friendly purpose.

A bushing of a bearing and a toothed loop for a variable speed bicycle in accordance with a preferred embodiment of the present invention comprises: at least one dove-tail recess and at least one dove-tail retaining projection, both of which are fixed on two sides of a metal piece respectively;

a toothed loop including a small-diameter hole disposed on a central portion thereof, and the small-diameter hole including a large-diameter annular groove mounted on an upper side thereof, and the large-diameter annular groove including a plurality of teeth formed therearound;

wherein the dove-tail recess includes two opposite first titled surfaces arranged on two sides thereof individually, and the dove-tail retaining projection includes two opposite second titled surfaces arranged on two sides thereof individually, and the metal piece is twisted to form a hollow cylinder so that the dove-tail recess and the dove-tail projection are connected together, and then they are engages with each other by using the first and second titled surfaces;

the toothed loop is rejection molded from non-metal composite material.

### BRIEF DESCRIPTION OF THE DRAWINGS

FIG. 1 is a perspective view of a conventional bushing;

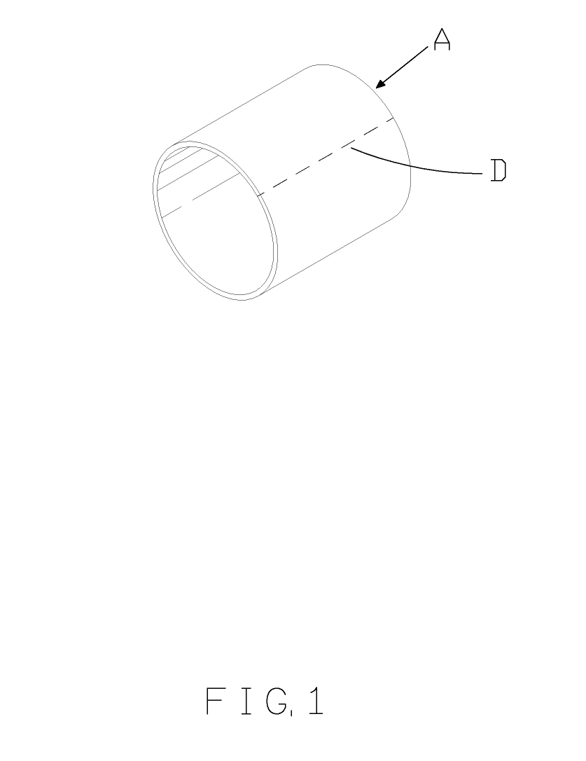

FIG. 2 is a perspective view showing the operation of the conventional bushing;

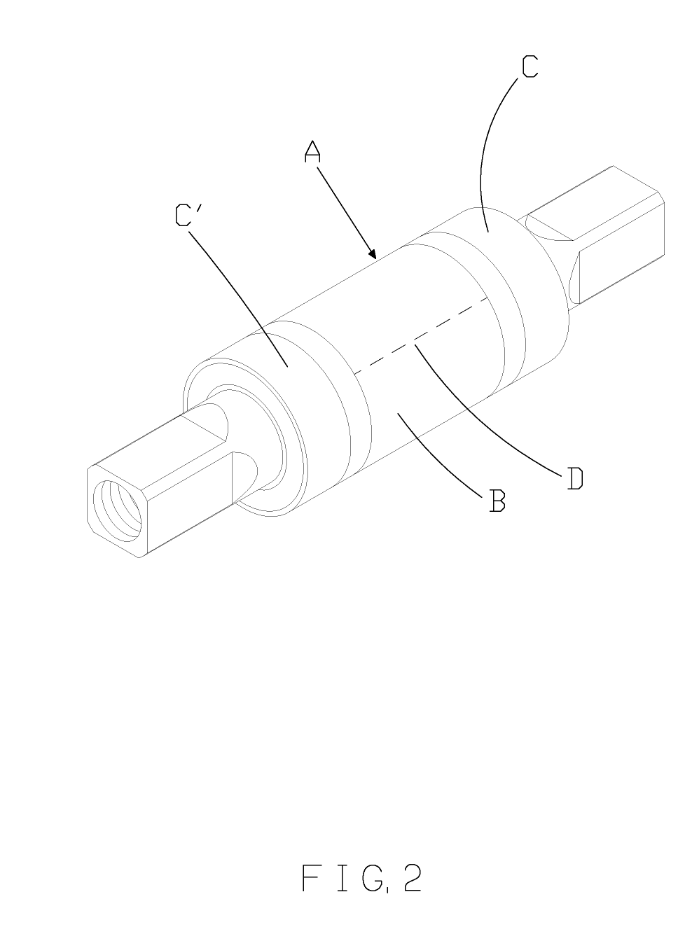

FIG. 3 is a perspective view of a conventional toothed loop;

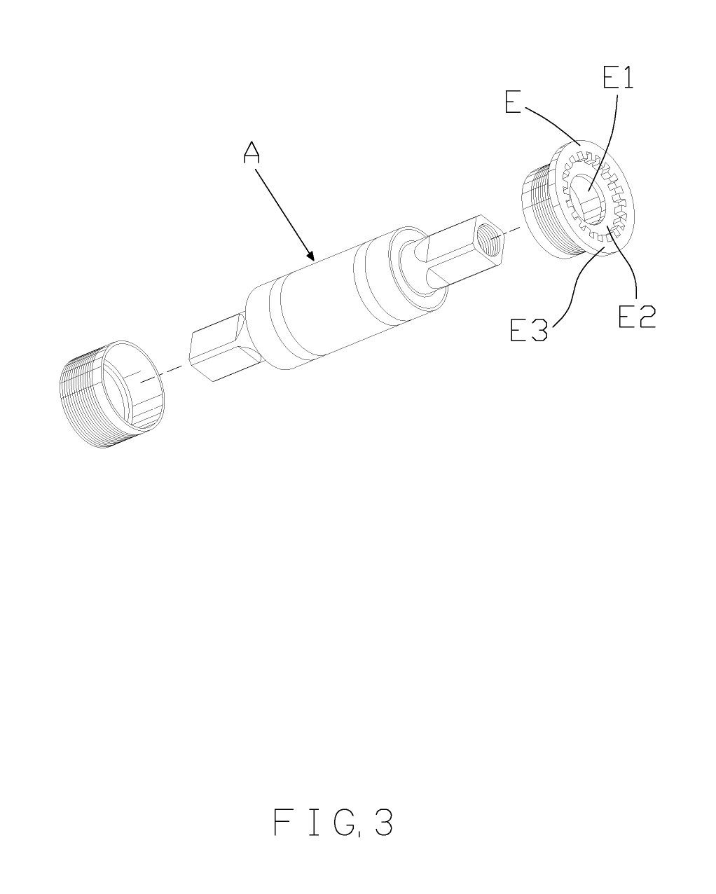

FIG. 4 is another perspective view of the conventional toothed loop n;

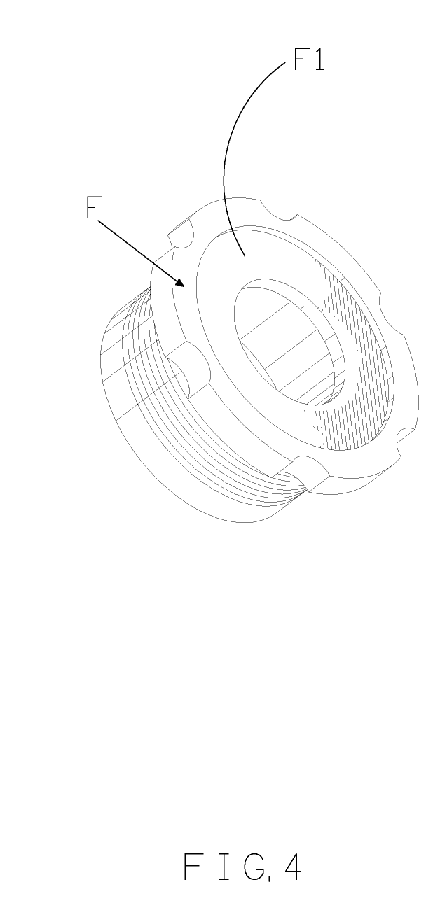

FIG. 5 is a perspective view showing the exploded components of an unformed bushing according to a preferred embodiment of the present invention;

FIG. 6 is a perspective view showing the exploded components of a formed bushing according to the preferred embodiment of the present invention;

FIG. 7 is a perspective view showing the operation of the bushing according to the preferred embodiment of the present invention;

FIG. 8 is a perspective view showing the exploded components of a toothed loop according to a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

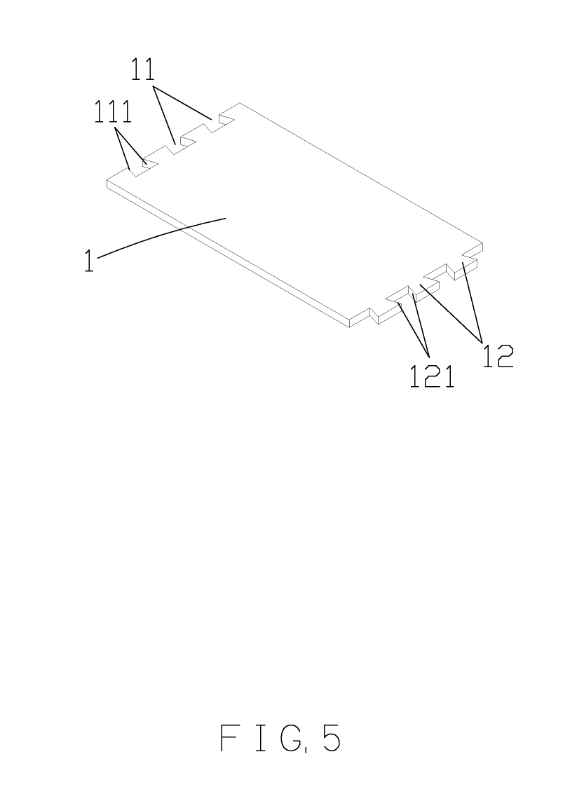

Referring to FIG. 5, a bushing of a bearing for a variable speed bicycle in accordance with a preferred embodiment of the present invention comprises at least one dove-tail recess 11 and at least one dove-tail retaining projection 12, both of which are fixed on two sides of a metal piece respectively, wherein the dove-tail recess 11 includes two opposite first titled surfaces 111 arranged on two sides thereof individually, and the dove-tail retaining projection 12 includes two opposite second titled surfaces 121 arranged on two sides thereof individually.

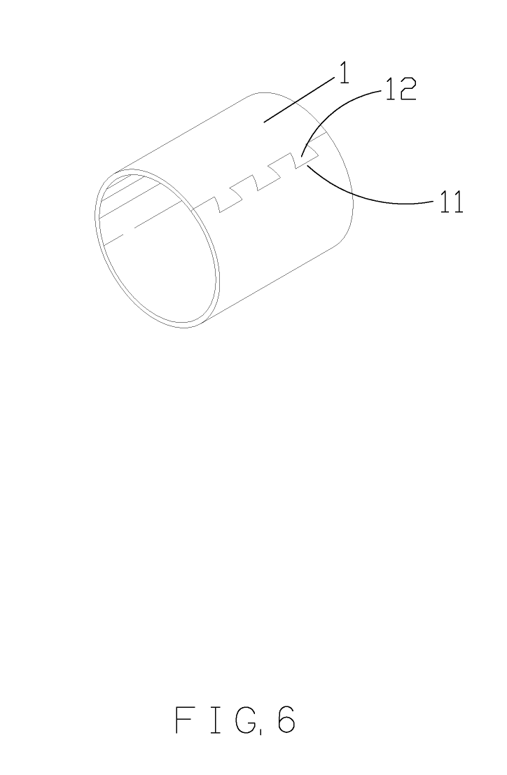

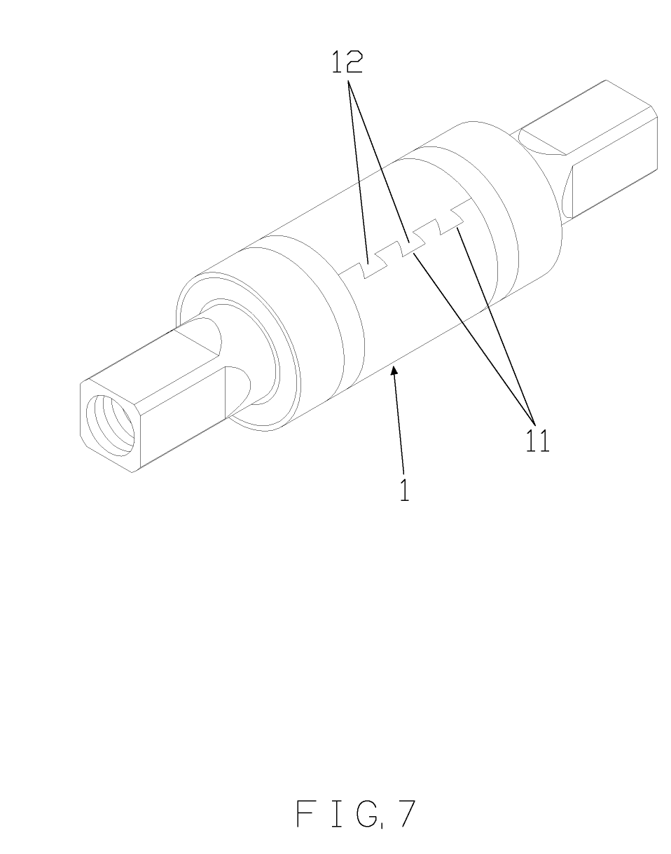

As shown in FIGS. 6 and 7, the metal piece 1 is twisted to form a hollow cylinder so that the dove-tail recess 11 and the dove-tail projection 12 are connected together, and then they are engages with each other by using the first and second titled surfaces 111, 121, thus obtaining a formed bushing.

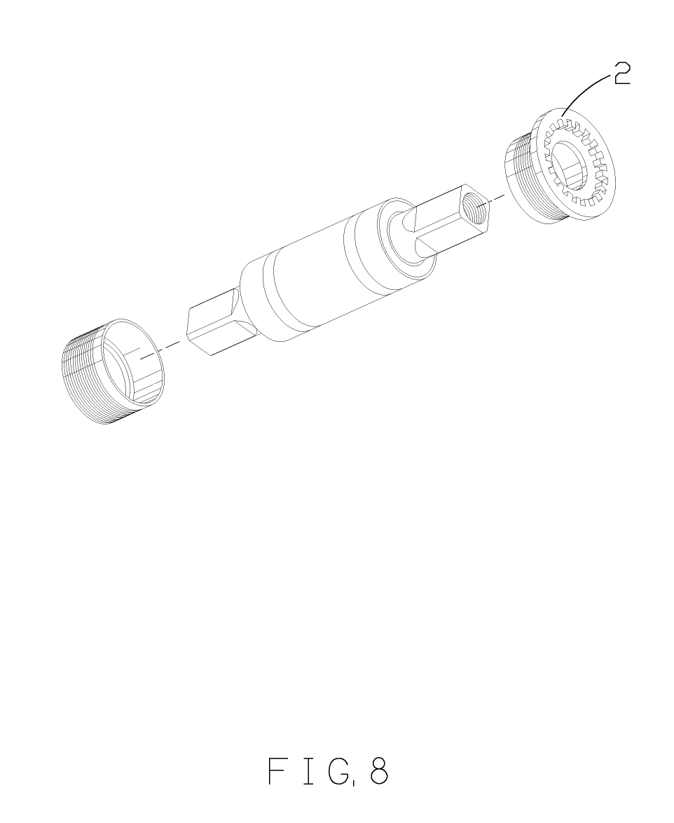

With reference to FIG. 8, a toothed loop in accordance with a preferred embodiment of the present invention is made of non-metal composite material, and includes a small-diameter hole disposed on a central portion thereof, and the small-diameter hole includes a large-diameter annular groove mounted on an upper side thereof, and the large-diameter annular groove includes a plurality of teeth formed therearound. The toothed loop 2 is rejection molded from non-metal composite material to enhance production quantity, to lower defect rate and production cost, and to prevent from rust, and to obtain environmental friendly purpose.

While we have shown and described various embodiments in accordance with the present invention, it is clear to those skilled in the art that further embodiments may be made without departing from the scope of the present invention.

What is claimed is:

1. A bushing of a bearing and a toothed loop for a variable speed bicycle comprising
at least one dove-tail recess and at least one dove-tail retaining projection, both of which are fixed on two sides of a metal piece respectively;
a small-diameter hole disposed on a central portion of the toothed loop, and the small-diameter hole including a large-diameter annular groove mounted on an upper side thereof, the large-diameter annular groove including a plurality of teeth formed therearound;
wherein the dove-tail recess includes two opposite first titled surfaces arranged on two sides thereof individually, and the dove-tail retaining projection includes two opposite second titled surfaces arranged on two sides thereof individually, and the metal piece is twisted to form a hollow cylinder so that the dove-tail recess and the dove-tail projection are connected together, and then they are engages with each other by using the first and second titled surfaces;
the toothed loop is rejection molded from non-metal composite material.
